(19) United States
(12) Patent Application Publication
(10) Pub. No.: US 2026/0239011 A1
(43) Pub. Date: Aug. 13, 2026

(54) MANAGEMENT OF MULTIPLE BASIC SERVICE SET IDENTIFIER (MBSSID) GROUPS FOR BEACON PROTECTION

(71) Applicant: HEWLETT PACKARD ENTERPRISE DEVELOPMENT LP, Spring, TX (US)

(72) Inventors: Jiyong Li, Beijing (CN); Feng Ding, Beijing (CN); Yunfei Bu, Beijing (CN); Ting Guo, Beijing (CN); Xiaozhi Zhang, Beijing (CN)

(21) Appl. No.: 19/047,869

(22) Filed: Feb. 7, 2025

(51) Int. Cl. H04L 9/32; H04W 12/03

(52) U.S. Cl. CPC H04L 9/3242; H04W 12/03

(57) ABSTRACT

Examples described herein relate to an Access Point (AP) and a method for managing Multiple Basic Service Set Identifier (MBSSID) groups. The AP may receive a configuration of a target Virtual Access Point (VAP) including information about a first encryption algorithm. In response to determining that the first encryption algorithm does not match with an encryption algorithm corresponding to one of a plurality of transmitting VAPs of a plurality of MBSSID groups configured for a radio of the AP, the AP may create an additional MBSSID group for the target VAP. Further, the AP may configure the target VAP as a transmitting VAP for the additional MBSSID group, and transmit a management frame corresponding to the additional MBSSID group comprising security information corresponding to the first encryption algorithm.

### BACKGROUND

With the advancements in wireless networking technologies, wireless networking devices such as Access Points (APs) allow the creation of Virtual Access Points (VAPs). Each of these VAPs is configured with a unique Basic Service Set Identifier (BSSID) and appears as an individual AP to client devices. In some implementations, to improve airtime efficiency, support for a Multiple Basic Service Set Identifier (MBSSID) is suggested in 802.11ax Specification by the Institute of Electrical and Electronics Engineers (IEEE) (hereinafter referred to as IEEE 802.11ax Specification).

An MBSSID represents a collection of all the VAPs configured on the AP in which one of the VAPs is configured as a transmitting VAP or transmitted VAP and the rest of the VAPs are configured as non-transmitting VAPs or non-transmitted VAPs. Per the IEEE 802.11ax Specification, an AP configured with the MBSSID can send a common beacon for the MBSSID instead of individual beacons for each VAP. Further, recent Wi-Fi standards such as the IEEE 802.11be (also known as Wi-Fi 7) generally promise to significantly boost the speed and stability of wireless connections while offering lower latency and seamlessly managing an increased number of connections compared to the prior Wi-Fi Standards. In particular, IEEE 802.11be requires that the beacons be protected using appropriate encryption algorithms.

### BRIEF DESCRIPTION OF THE DRAWINGS

One or more examples in the present disclosure are described in detail with reference to the following Figures. The Figures are provided for purposes of illustration only and merely depict examples.

FIG. 1 depicts a block diagram of a wireless networking device in which various of the examples presented herein may be implemented.

FIG. 2 depicts a flowchart of an example method for managing Multiple Basic Service Set Identifier (MBSSID) groups.

FIG. 3 depicts a flowchart of another example method for managing MBSSID groups for a newly created virtual access point (VAP).

FIG. 4 depicts a flowchart of yet another example method for managing MBSSID groups for an updated VAP.

FIG. 5 depicts a block diagram of an example computing system.

The Figures are not exhaustive and do not limit the present disclosure to the precise form disclosed.

### DETAILED DESCRIPTION

Advances in wireless networking technologies drive technological improvements in other technologies and industries. For example, various industries rely on wireless networking technologies to deliver data and/or services. In wireless networks, client devices wirelessly connect to a network through an AP. Increasing usage of wireless networking technologies, among other factors, creates various technological challenges in the field of wireless networking. The Institute of Electrical and Electronics Engineers (IEEE) has issued various standard Specifications, such as the 802.11 Specifications to address various challenges in the field of wireless networking technologies. For instance, as various technologies increasingly rely on wireless networking technologies, there becomes a need to expand the capabilities of wireless networks to accommodate larger numbers of devices with varying configurations. For example, configuring the virtual access points (VAPs) on an access point (AP) allows the AP to present itself as multiple APs. To client devices, a VAP appears as a separate AP. A VAP can be configured with respective network properties, such as authentication and encryption, and is identified via a unique Basic Service Set Identifier (BSSID). Thus, each VAP can be associated with a BSSID configured with a set of network properties associated with the VAP.

Typically, an AP announces a wireless network by transmitting a beacon frame. In the case of an AP configured with multiple VAPs, the AP typically broadcasts a beacon frame for each VAP of the multiple VAPs, where the beacon frame includes a BSSID associated with the VAP. The beacon frames are broadcast to the client devices. The client devices use the BSSID included in the beacon frames to determine a VAP to connect. In some deployments, an AP can support multiple wireless networks using multiple VAPs. In these deployments, broadcasting a separate beacon frame for each VAP (i.e., for each BSSID) may be inefficient and degrade the connection quality of the wireless networks.

A technique to address the inefficiencies and network degradation associated with broadcasting separate beacon frames entails implementing a Multiple Basic Service Set Identifier (MBSSID) in accordance with IEEE 802.11ax. An MBSSID is a group of VAPs hosted on an AP for which the AP can use common management frames, such as beacons and probes, for example. A beacon frame corresponding to the MBSSID is hereinafter referred to as an MBSSID beacon. In the MBSSID beacon, a BSSID field is set to a BSSID of one of the VAPs of the MBSSID. The VAP whose BSSID is used in the BSSID field in the MBSSID beacon is referred to as a transmitted VAP and its BSSID is referred to as a transmitted BSSID. The rest of the VAPs of the MBSSID are referred to as non-transmitted VAPs and their BSSIDs are referred to as non-transmitted BSSIDs. Broadcasting the MBSSID beacons allows the AP to use fewer beacon frames than the AP would by broadcasting separate beacon frames individually for each VAP.

While the use of the MBSSID allows APs to broadcast information associated with a plurality of VAPs forming the MBSSID with improved airtime efficiency, the use of the MBSSID faces certain technological challenges. For example, Wi-Fi 7 (IEEE 802.11be) introduces several enhancements to improve wireless network efficiency, security, and performance. Among these enhancements are features related to beacon protection, especially in the context of MBSSID. Beacon protection ensures the integrity and authenticity of beacon frames, which are critical for network operation and management. In particular, the use of MBSSID may face challenges in adhering to Wi-Fi 7 as Wi-Fi 7 capable APs must support both the MBSSID and Beacon Protection features.

Beacon protection in Wi-Fi 7 with MBSSID involves certain encryption mechanisms to ensure that the beacon frames are transmitted efficiently and securely. In particular, Wi-Fi 7 includes enhancements to overall network security. This can involve stronger encryption methods and authentication protocols to ensure that only authorized devices can connect to the network. For instance, the beacon protection feature in Wi-Fi 7 with MBSSID leverages group management cipher suites, Beacon Integrity Group Temporal Key (BIGTK), and BIGTK packet number (BIPN) to ensure the integrity and authenticity of beacon frames. These mechanisms collectively enhance the security and reliability of Wi-Fi networks, allowing for efficient management of multiple SSIDs from a single access point while protecting critical network information from tampering and spoofing. A “group management cipher suite” in relation to a BSSID refers to the specific encryption algorithm for protecting management frames (e.g., beacon frames) within a wireless network identified by that BSSID. The BIGTK is a cryptographic key (e.g., a random value), assigned by an AP, which is used to protect Beacon frames from that AP. The BIGTK is securely distributed to authorized devices, allowing them to verify the authenticity of received frames.

The IEEE specification mentions that, for multiple BSSIDs, each Authenticator (e.g., an AP) shall maintain and transmit the BIGTK and BIPN which are common to all of the co-located transmitted and non-transmitted VAPs, and the Supplicant (e.g., a client device) uses the received BIGTK and BIPN to maintain a Beacon Integrity Group Temporal Key Security Association (BIGTKSA). If a Supplicant that has a BIGTKSA with an Authenticator that is using a non-transmitted BSSID receives a protected Beacon frame from the AP with the transmitted BSSID, the Supplicant shall execute the Broadcast/Multicast Integrity Protocol (BIP) procedures to validate the beacon frame. While this outlines a basic framework, it does not address the issue of handling different group management cipher suites within the same group of BSSIDs. This can create problems because each cipher suite uses a distinct algorithm, leading to potential mismatches when validating the beacon frames.

For instance, there are four group management cipher suites, for example, BIP-Cipher-based Message Authentication Code (CMAC)-128, BIP-CMAC-256, BIP-Galois Message Authentication Code (GMAC)-128, and BIP-GMAC-256, that can be used to protect beacon frames. If a non-transmitted BSSID is configured with a different group management cipher suite than the transmitted BSSID in the same MBSSID group, Wi-Fi 7 capable clients cannot connect to the non-transmitted BSSID. This is because the BIGTK which is generated by the group management cipher suite of the transmitted BSSID and shared with the client devices cannot be verified during a handshake process with the non-transmitted BSSID. By way of example, If the transmitted BSSID uses BIP-CMAC-128 or BIP-GMAC-128, but the non-transmitted BSSIDs rely on BIP-GMAC-256 or BIP-CMAC-256, the shared BIGTK may not be sufficient because the key length for the 256-bit cipher suites exceeds that of the 128-bit ones. Similarly, if the transmitted BSSID uses BIP-CMAC-128 and the non-transmitted BSSIDs use BIP-GMAC-128, the Supplicant may incorrectly apply the wrong cipher algorithm to validate Beacon frames. This results in invalid outcomes despite having a shared BIGTK.

To address the aforementioned challenges, in examples consistent with the teachings of this disclosure, an access point (AP) is configured with an enhanced mechanism for managing MBSSID groups considering the encryption algorithms (e.g., group management cipher suites) for VAPs configured for a radio of the AP. In particular, the AP is configured to intelligently adjust existing MBSSID groups or create additional MBSSID groups based on the group management cipher suite, ensuring that the VAPs within the same MBSSID group have the same group management cipher suite. In an example implementation, a proposed method of managing MBSSID groups involves a series of steps performed by the proposed AP. Initially, the AP assesses whether the encryption algorithm used by a target VAP matches any of the encryption algorithms of the existing transmitting VAPs. If the AP determines that there is no match between the target VAP's encryption algorithm and those of the currently transmitting VAPs, it proceeds to create an additional MBSSID group specifically for the target VAP. This step ensures that the target VAP operates within a secure and compatible encryption framework. Subsequently, the AP configures the target VAP as a transmitting VAP within this new MBSSID group, thereby integrating it into the network while maintaining the integrity and security of the encryption protocols across all VAPs. This method enhances network security and organization by ensuring that each VAP adheres to its designated encryption standards.

In one example, the proposed method of managing MBSSID groups may be performed while creating a new VAP. For instance, the proposed method involves a series of steps executed by an AP to manage and secure Virtual Access Points (VAPs) within a radio system that supports multiple Basic Service Set Identifier (MBSSID) groups. Initially, the AP identifies that a target VAP has been created for a specific radio and is associated with a particular group management cipher suite. For instance, the AP may detect a new VAP entry comprising a configuration corresponding to the target VAP indicating the creation of the target VAP for a radio. The configuration may include information about a first group management cipher suite corresponding to the target VAP, and wherein the radio is configured with a plurality of MBSSID groups. Further, the AP may fetch the configuration responsive to detecting the new VAP entry.

The AP then checks whether the first group management cipher suite matches any of the group management cipher suites used by the existing transmitting VAPs within these MBSSID groups. If the AP determines that there is no match between the target VAP's group management cipher suite and those of the existing transmitting VAPs, the AP creates an additional MBSSID group specifically for the target VAP. Following this, the AP configures the target VAP as a transmitting VAP within the newly established additional MBSSID group. After the target VAP has been configured as the transmitting VAP for the additional MBSSID group, the AP may transmit a beacon corresponding to the additional MBSSID group encrypted using the first group management cipher suite.

In another example, the proposed method of managing MBSSID groups may be performed by an AP when an existing VAP is updated to modify its group management cipher suite. For instance, the AP may first determine that the configuration of a target VAP has been updated, specifically by replacing its previously assigned first group management cipher suite with a new, second group management cipher suite. Given that the radio is configured with multiple MBSSID groups, the AP may check whether this new cipher suite matches any of the group management cipher suites used by the currently transmitting VAPs within these MBSSID groups. If it is determined that the second cipher suite does not match any of the cipher suites of the transmitting VAPs, the AP may create an additional MBSSID group specifically for the target VAP. This ensures that the target VAP can operate within a compatible and secure encryption framework. Finally, the AP may configure the target VAP as a transmitting VAP for the newly created MBSSID group.

As will be appreciated, the proposed method maintains network security and efficiency by ensuring that VAPs with different encryption requirements are properly segregated into distinct MBSSID groups, preventing any conflicts in group management cipher suites. Also, having VAPs that use the same group management cipher suite in one MBSSID group may ensure that the client device receiving beacons has appropriate keys to securely connect with any of the transmitted VAP or the non-transmitted VAPs of the MBSSID group.

The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

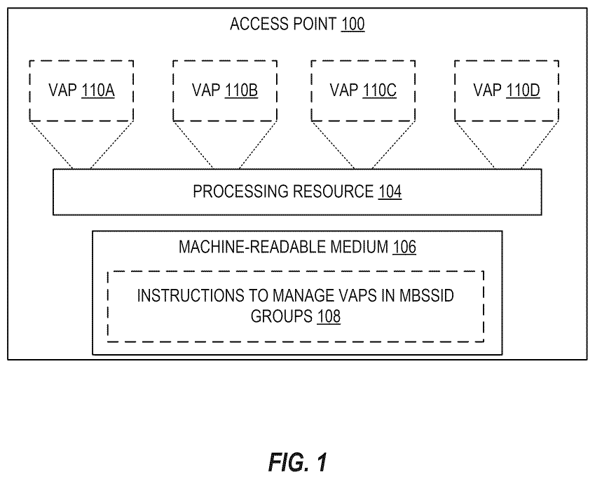

FIG. 1 illustrates a wireless networking device, for example, an access point (AP) 100 in which various of the examples presented herein may be implemented. The AP 100 may be implemented in any setup, for example, in a home setup or an organization, such as a business, educational institution, governmental entity, healthcare facility, or other organization.

In particular, the AP 100 may be a networking device capable of providing wireless connectivity to the client devices thereby enabling the client devices to communicate with other electronic devices (not shown in FIG. 1). The AP 100 may include a combination of hardware, software, and/or firmware that is configured to provide wireless network connectivity to the client device. In particular, the AP 100 may act as a point of access to the client devices connecting to the AP 100. In some examples, the AP 100 may comprise, be implemented as, or known as a radio router, radio transceiver, a switch, a Wi-Fi hotspot device, Basic Service Set (BSS) device, Extended Service Set (ESS) device, radio base station (RBS), or some other terminology and may act as a point of network access for the client devices connecting to the AP 100.

The AP 100 may be implemented with one or more radios to help the AP 100 communicate with the client devices and other wireless-capable devices. Each radio of the AP 100 may operate on a respective range of radio frequency ranges, referred to as a Wi-Fi band, for example, the 2.4 Gigahertz (GHz) Wi-Fi band, 5 GHz Wi-Fi band, the 6 GHz Wi-Fi band, and so on. Although not shown, in some examples, the AP 100 may include additional network devices such as, but not limited to, additional APs, wireless local area network (WLAN) controllers, network switches, gateway devices, routers, and the like. Via the AP 100, the client devices may communicate with each other and/or with any other network device to which the AP 100 is communicatively connected (e.g., the network switches, the WLAN controller, and/or gateway devices).

The client devices connecting to the AP 100 may be electronic devices capable of wirelessly communicating with an AP 100 or other electronic devices. Examples of client devices may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, smart terminals, dumb terminals, virtual terminals, video game consoles, virtual assistants, Internet of Things (IoT) devices, and the like. Communications between the AP 100 and the client devices may be facilitated via wireless communication links established according to wireless communication protocols such as the IEEE 802.11 standards, Wi-Fi Alliance Specifications, or any other wireless communication standards. In some examples, the communication between the client devices and the AP 100 may be carried out in compliance with IEEE 802.11ax Specification.

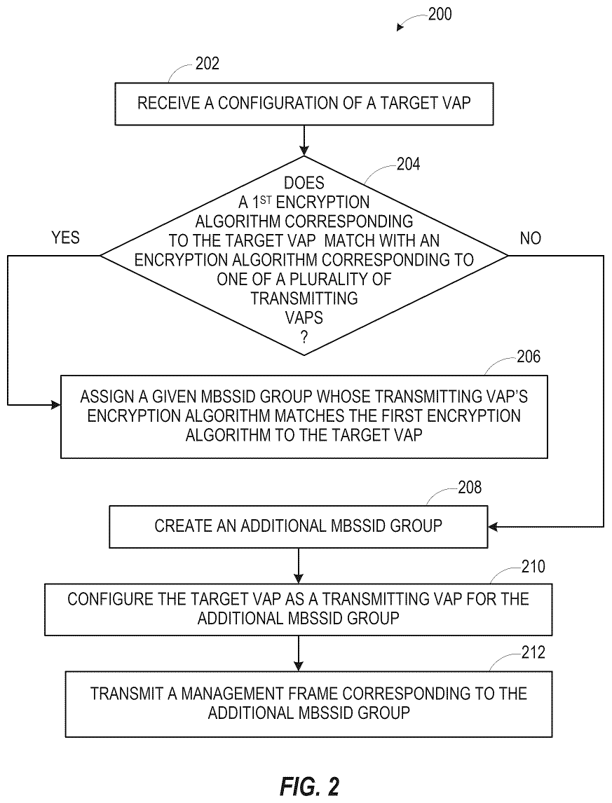

In some examples, the AP 100 may include a processing resource 104 and/or a machine-readable storage medium 106 for the AP 100 to execute several operations as will be described in the greater details below. The machine-readable storage medium 106 may be non-transitory and is alternatively referred to as a non-transitory machine-readable storage medium that does not encompass transitory propagating signals. The machine-readable storage medium 106 may be any electronic, magnetic, optical, or other storage device that may store data and/or executable instructions. Examples of the machine-readable storage medium 106 that may be used in the AP 100 may include Random Access Memory (RAM), non-volatile RAM (NVRAM), an Electrically Erasable Programmable Read-Only Memory (EEPROM), a storage drive (e.g., a solid-state drive (SSD) or a hard disk drive (HDD)), a flash memory, and the like. The machine-readable storage medium 106 may be encoded with executable instructions 108 (depicted using a dashed box in FIG. 1) for managing VAPS in MBSSID groups, more particularly, managing encryption of the management frames for the VAPS across multiple MBSSID groups. Although not shown, in some examples, the machine-readable storage medium 106 may be encoded with certain additional executable instructions causing the processing resource to perform any other operations (e.g., operations described in conjunction with FIGS. 2-4) intended to be performed by the AP 100, without limiting the scope of the present disclosure.

The processing resource 104 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 106, or combinations thereof. The processing resource 104 may fetch, decode, and execute the instructions 108 stored in the machine-readable storage medium 106 to configure MBSSID groups for the AP 100 and manage VAPS in MBSSID groups, more particularly, manage encryption of the management frames for the VAPS across multiple MBSSID groups. As an alternative or in addition to executing the instructions 108, the processing resource 104 may include at least one integrated circuit (IC), control logic, electronic circuits, or combinations thereof that include a number of electronic components for performing the functionalities intended to be performed by the AP 100.

Further, as shown in FIG. 1, the AP 100 may be configured with a set of logical entities such as VAPs 110A, 110B, 110C, and 110D (hereinafter collectively referred to as VAPs 110A-110D) that are depicted using dashed boxes in FIG. 1. In particular, configuration files and program instructions (not shown) to execute the VAPs 110A-110D are stored in the machine-readable storage medium 106. A configuration file for a given VAP may include settings such as radio details, SSID, channel information, a BSSID, communication capabilities, and the like. Each of the VAPs 110A-110D is associated with a unique BSSID configured with a set of network properties associated with the VAP. A BSSID of a given VAP may act as a unique address for the given VAP. In one example, the BSSID may be expressed as a unique string of hexadecimal numbers of predefined length. The processing resource 104 may execute program instructions according to the respective configuration files to enable the functioning of the VAPs 110A-110D.

A VAP appears as an independent AP with a wireless network name, commonly referred to as, a service set identifier (SSID). In the example implementation of FIG. 1, the VAPs 110A, 110B, 110C, and 110D configured on the AP 100 may appear as two independent APs advertised via respective SSIDs to the client devices discovering the wireless networks. For illustration purposes, the AP 100 is shown as configured with four VAPs 110A-110D. In some examples, the AP 100 may be configured with greater or fewer VAPs than depicted in FIG. 1 without limiting the scope of the present disclosure. In certain implementations, the number of VAPs configured on a particular radio of an AP such as the AP 100 may be restricted to a VAP capacity of the AP 100. The VAP capacity may refer to the maximum number of VAPs that can be created for a given radio of an AP, for example, the AP 100. For example, the AP may have a VAP capacity of 16 per radio of the AP 100. For illustration purposes, the VAPs 110A-11D are configured for one radio of the AP. Client devices may associate with any of the VAPs 110A-110D as if they are associating with any physical AP.

In the present implementation of FIG. 1, the AP 100 may be configured to implement Multiple Basic Service Set Identifier (MBSSID) functionality per Wi-Fi Standards. An MBSSID group may be formed for a set of VAPs hosted on an AP (e.g., the AP 100) allowing the AP to use common management frames, such as beacons and probes, for example, for the set of VAPs. In the present implementation, the AP 100 may allow the formation of a plurality of MBSSID groups. It may be noted that the AP 100 may allow the formation of a predefined number (which may be a customizable value, in some examples) of VAPs in each MBSSID group. The maximum count of VAPs in each MBSSID group (VAP_{GroupMAXcount}) is determined as 2^{MAXBSSID}^{_{Indicator}}, wherein MAXBSSID_{Indicator} represents the Maximum BSSID indicator. The maximum count of VAPs that may be configured in each MBSSID group is referred to as a VAP capacity of an MBSSID group. As such, the Maximum BSSID indicator dictates the maximum count of VAPs in each MBSSID group. In some examples, the value of the Maximum BSSID indicator is selected such that all of the MBSSID groups have an equal number of VAP slots available to accommodate VAPs therein. For instance, for an AP with a VAP capacity of 16 per radio, the Maximum BSSID indicator may be set to 2 (e.g., MAXBSSID_{Indicator}=2), which in turn allows each MBSSID group to accommodate 4 VAPs. In some examples, the AP 100 may also allow dynamic VAP capacity allowing a user to customize the VAP capacity of one or more MBSSID groups.

The AP 100 may transmit a separate beacon frame (also referred to as an MBSSID beacon) for each of the plurality of MBSSID groups. In such MBSSID beacon, a BSSID field is set to a BSSID of one of the VAPs of the respective MBSSID group. The VAP whose BSSID is used in the BSSID field of the MBSSID beacon is referred to as a transmitted VAP (or a transmitting VAP) and its BSSID is referred to as a transmitted BSSID (or a transmitting BSSID). The rest of the VAPs of the MBSSID group are referred to as non-transmitted VAPs (or non-transmitting VAPs) and their BSSIDs are referred to as non-transmitted BSSIDs (or non-transmitting BSSIDs). Broadcasting these MBSSID beacons allows the AP to use fewer beacon frames than the AP would by broadcasting separate beacon frames individually for each VAP. Also, instead of sending one large beacon for all of the VAPs hosted on the AP 100, the individual MBSSID beacon for each MBSSID group would avoid beacon size bloating issues.

The proposed AP 100 enables beacon protection per Wi-Fi 7 (IEEE 802.11be). As previously noted, the beacon protection feature of Wi-Fi 7 (IEEE 802.11be) with MBSSID uses encryption mechanisms to ensure that the client devices can securely connect to VAPs of a particular MBSSID group. For instance, to enable the beacon protection feature of Wi-Fi 7, the AP 100 leverages, encryption algorithms, such as group management cipher suites, Beacon Integrity Group Temporal Key (BIGTK), and BIGTK packet number (BIPN) to ensure the integrity and authenticity of beacon frames. A “group management cipher suite” for a BSSID refers to the specific encryption algorithm for protecting management frames (e.g., beacon frames) within a wireless network identified by that BSSID. The BIGTK is a cryptographic key (e.g., a random value), assigned by an AP, which to protect Beacon frames from that AP. The BIGTK is securely distributed to authorized devices, allowing them to verify the authenticity of received frames.

The AP 100 may support a plurality of encryption algorithms to enable the beacon protection requirement of Wi-Fi 7. By way of example, in one implementation, the AP supports four group management cipher suites, for example, BIP-CMAC-128, BIP-CMAC-256, BIP-GMAC-128, and BIP-GMAC-256, that can be used to protect beacon frames. In accordance with examples presented in the present disclosure, the AP 100 may be configured to adjust existing MBSSID groups or create additional MBSSID groups based on the group management cipher suite used for the VAPs, ensuring that the VAPs within the same MBSSID group have the same group management cipher suite. For illustration purposes, in an example implementation, the VAPs 110A-110D are grouped into two MBSSID groups—MBSSD Group 1 (MG1) and MBSSID Group 2 (MG2), and the AP 100 protects respective beacons with the group management cipher suites as specified in an example VAP configuration depicted in Table 1. Further, Table 1 lists a VAP Type (e.g., transmitted VAP or non-transmitted VAP) corresponding to each of the VAPs 110A-110B.

TABLE 1
Example VAP Configuration

| | MBSSID | | Assigned Encryption |
|---|---|---|---|
| VAP | Group | VAP Type | Algorithm |
| VAP 110A | MG1 | Transmitted VAP | BIP-CMAC-128 |
| VAP 110B | MG1 | Non-Transmitted VAP | BIP-CMAC-128 |
| VAP 110C | MG2 | Transmitted VAP | BIP-GMAC-256 |
| VAP 110D | MG2 | Non-Transmitted VAP | BIP-GMAC-256 |

For the example VAP configuration specified in Table 1, the AP 100 may transmit two MBSSID beacons—one for MG1 and another for MG 2. To enable the beacon protection per Wi-Fi 7, the MBSSID beacon corresponding to MG1 may specify the BIGTK and BIPN corresponding to the group management cipher suite BIP-CMAC-128. Similarly, the MBSSID beacon corresponding to MG2 may specify the BIGTK and BIPN corresponding to the group management cipher suite BIP-GMAC-256. As will be appreciated, as both the transmitted VAP and the non-transmitted VAP in the MBSSID group MG1 use the same group management cipher suite (e.g., BIP-CMAC-128), a client device receiving the MBSSID beacon corresponding to MG1 can connect securely to any of the VAP 110A and 110B using the BIGTK and BIPN contained in the MBSSID of MG1. Similarly, a client device receiving the MBSSID beacon corresponding to MG2 can securely connect to any of the VAP 110C and 110D using the BIGTK and BIPN contained in the MBSSID of MG2 as both the transmitted VAP and the non-transmitted VAP in the MBSSID group MG2 use the same group management cipher suite (e.g., BIP-GMAC-256).

Whenever a new VAP is created or an existing VAP is updated, in accordance with the examples of the present disclosure, the AP 100 may assess whether the encryption algorithm (e.g., the group management cipher suite) used by such newly created VAP or the updated VAP matches any of the respective encryption algorithms of the existing transmitting VAPs. The target VAP may refer to a newly created VAP, or an existing VAP whose VAP configuration has been updated to alter the encryption algorithm. If the AP 100 determines that there is no match between the target VAP's encryption algorithm and those of the currently transmitting VAPs, the AP 100 may create an additional MBSSID group specifically for the target VAP. This step ensures that the target VAP operates within a secure and compatible encryption framework. Subsequently, the AP 100 may configure the target VAP as a transmitting VAP within this new MBSSID group, thereby integrating it into the network while maintaining the integrity and security of the encryption protocols across all VAPs.

By way of example, if a user (e.g., an administrator of the AP 100) creates a new VAP, such as, a VAP_N1 (i.e., a first target VAP) with a VAP configuration specified in Table 2 depicted below, the AP 100 may perform a series of steps to manage and secure the newly created VAP-VAP_N1.

TABLE 2
Example VAP Configuration of VAP_N1

| | MBSSID | | Assigned Encryption |
|---|---|---|---|
| VAP | Group | VAP Type | Algorithm |
| VAP_N1 | MG1 | Non-Transmitted VAP | BIP-CMAC-256 |

The example VAP configuration of VAP_N1 suggests that VAP_N1, at the time of creation, is assigned the MBSSID group MG1 and the group management cipher suite BIP-CMAC-256. However, the group management cipher suite assigned to VAP_N1 (i.e., BIP-CMAC-256) differs from the group management cipher suite of the transmitted VAP (e.g., the VAP 110A) of MG1.

When a new VAP, such as the VAP_N1 is configured, the AP 100 may check if the group management cipher suite of the new VAP matches any of the group management cipher suites used by the existing transmitting VAPs within these MBSSID groups MG1 and MG2. In the present example, the group management cipher suite of the VAP_N1 (i.e., BIP-CMAC-256) does not match the group management cipher suite of any of the transmitted VAPs of MG1 and MG2. If the AP 100 determines that there is no match between a first target VAP's group management cipher suite and those of the existing transmitting VAPs, the AP 100 creates an additional MBSSID group specifically for VAP_N1. In the present example, as the group management cipher suite of the VAP_N1 does not match the group management cipher suite of any of the transmitted VAPs of MG1 and MG2, the AP 100 may create an additional MBSSID group, for example, an MBSSID group 3 (MG3).

After creating the additional MBSSID group, the AP 100 may configure the first target VAP (VAP_N1) as a transmitting VAP within the newly established additional MBSSID group. Table 3 below represents an updated VAP configuration after the AP 100 has created the new MBSSID group 3 for VAP_N1 as the transmitted VAP.

TABLE 3
Example updated VAP configuration after processing VAP_1

| | MBSSID | | Assigned Encryption |
|---|---|---|---|
| VAP | Group | VAP Type | Algorithm |
| VAP 110A | MG1 | Transmitted VAP | BIP-CMAC-128 |
| VAP 110B | MG1 | Non-Transmitted VAP | BIP-CMAC-128 |
| VAP 110C | MG2 | Transmitted VAP | BIP-GMAC-256 |
| VAP 110D | MG2 | Non-Transmitted VAP | BIP-GMAC-256 |
| VAP_N1 | MG3 | Transmitted VAP | BIP-CMAC-256 |

After the first target VAP (e.g., VAP_N1) has been configured as the transmitting VAP for the additional MBSSID group (e.g., MG3), the AP 100 may transmit a beacon corresponding to the additional MBSSID group encrypted using the group management cipher suite (e.g., BIP-CMAC-256) assigned to the first target VAP.

In yet another example, if an additional new VAP such as VAP_N2 (i.e., a second target VAP) is created with the group management cipher suite BIP-GMAC-256 and configured as a non-transmitted VAP for MG1, the AP 100 may determine that the group management cipher suite of VAP_N2 matches with the group management cipher suite of VAP 110C that is the transmitted VAP of MG2. Accordingly, the AP 100 may assign MG2 to VAP_N2 and configure VAP_N2 as a non-transmitted VAP in MG2. Table 4 below represents an updated VAP configuration after the second target VAP (e.g., VAP_N2) is configured as the non-transmitted VAP in MG2.

TABLE 4
Example updated VAP configuration after processing VAP_N2

| | MBSSID | | Assigned Encryption |
|---|---|---|---|
| VAP | Group | VAP Type | Algorithm |
| VAP 110A | MG1 | Transmitted VAP | BIP-CMAC-128 |
| VAP 110B | MG1 | Non-Transmitted VAP | BIP-CMAC-128 |
| VAP 110C | MG2 | Transmitted VAP | BIP-GMAC-256 |
| VAP 110D | MG2 | Non-Transmitted VAP | BIP-GMAC-256 |
| VAP_N1 | MG3 | Transmitted VAP | BIP-CMAC-256 |
| VAP_N2 | MG2 | Non-Transmitted VAP | BIP-GMAC-256 |

After the second target VAP (e.g., VAP_N2) has been configured as the non-transmitting VAP for MG2, the AP 100 may modify the beacon corresponding to MG2 to include details about the newly configured non-transmitting VAP in MG2.

In another example, the AP 100 may also be configured to manage VAPs whose configurations have been updated to modify the encryption algorithms (e.g., the group management cipher suite) similarly as described above. For instance, the AP 100 may first determine that the configuration of any VAP has been updated, specifically by replacing its previously assigned first group management cipher suite with a second group management cipher suite. Given that the radio of the AP 100 is configured with multiple MBSSID groups, the AP 100 may check whether the second group management cipher suite matches any of the group management cipher suites used by the currently transmitting VAPs within these MBSSID groups MG1-MG3, for example. If it is determined that the second group management cipher suite does not match any of the group management cipher suites corresponding to the transmitting VAPs, the AP 100 may create an additional MBSSID group specifically for the updated target VAP. If an additional MBSSID for the updated VAP is created, the AP 100 may configure the updated VAP as a transmitting VAP for the newly created MBSSID group.

In one example scenario, existing VAPs such as VAPs 110B and 110D are updated to modify the respective group management cipher suites to BIP-GMAC-128 and BIP-CMAC-256, respectively. Table 5 below represents an updated VAP configuration after the VAPs 110B and 110D have been updated.

TABLE 5
Example VAP configuration after updating VAPs 110B and 110D

| | MBSSID | | Assigned Encryption |
|---|---|---|---|
| VAP | Group | VAP Type | Algorithm |
| VAP 110A | MG1 | Transmitted VAP | BIP-CMAC-128 |
| VAP 110B | MG1 | Non-Transmitted VAP | BIP-GMAC-128 |
| VAP 110C | MG2 | Transmitted VAP | BIP-GMAC-256 |
| VAP 110D | MG2 | Non-Transmitted VAP | BIP-CMAC-256 |
| VAP_N1 | MG3 | Transmitted VAP | BIP-CMAC-256 |
| VAP_N2 | MG2 | Non-Transmitted VAP | BIP-GMAC-256 |

For effective beacon protection, the AP 100 may dynamically assign an appropriate MBSSID group to each of the updated VAPs 110B and 110D. For example, for updated VAP 110B (i.e., a third target VAP), the AP 100 may determine that the new group management cipher suite BIP-GMAC-128 does not match with the group management cipher suites of any of the transmitting VAPs 110A, 110C, VAP_N1. Therefore, the AP 100 may create an additional MBSSID group (e.g., an MBSSID group 4-MG4) specifically for the updated VAP 110B and configure the updated VAP 110B as a transmitting VAP for the newly created MBSSID group. Further, for updated VAP 110D (i.e., a fourth target VAP), the AP 100 may determine that the new group management cipher suite BIP-CMAC-256 matches with the group management cipher suite of the transmitting VAP VAP_1. Therefore, the AP 100 may configure the updated VAP 110D as a non-transmitting VAP for MG3. Table 6 below represents an updated VAP configuration after the updated VAPs 110B and 110D have been reconfigured with the appropriate MBSSID groups.

TABLE 6
Example VAP configuration after processing updated VAPs 110B and 110D

| | MBSSID | | Assigned Encryption |
|---|---|---|---|
| VAP | Group | VAP Type | Algorithm |
| VAP 110A | MG1 | Transmitted VAP | BIP-CMAC-128 |
| VAP 110B | MG4 | Transmitted VAP | BIP-GMAC-128 |
| VAP 110C | MG2 | Transmitted VAP | BIP-GMAC-256 |
| VAP 110D | MG3 | Non-Transmitted VAP | BIP-CMAC-256 |
| VAP_N1 | MG3 | Transmitted VAP | BIP-CMAC-256 |
| VAP_N2 | MG2 | Non-Transmitted VAP | BIP-GMAC-256 |

As will be appreciated, the proposed method maintains network security and efficiency by ensuring that VAPs (e.g., VAPs 110A-110D and VAP_N1, VAP_N2) with different encryption requirements are properly segregated into distinct MBSSID groups, preventing any conflicts in group management cipher suites. Also, having VAPs that use the same group management cipher suite in one MBSSID group may ensure that the client device receiving beacons has appropriate keys to securely connect with any of the transmitted VAP or the non-transmitted VAPs of the MBSSID group.

Additional details about managing VAPs are described in conjunction with the methods described in FIGS. 2-4.

In the description hereinafter, various operations performed by a wireless networking device, for example, the AP 100, are described with the help of flowcharts depicted in FIGS. 2-4. FIGS. 2-4 depict flowcharts of example methods for managing MBSSID groups. The steps that are shown in FIGS. 2-4 may be performed locally at any suitable device, such as a wireless networking device (e.g., the AP 100 of FIG. 1). In some examples, the suitable device may include a processing resource suitable for retrieval and execution of instructions (e.g., the instructions 108) stored in a machine-readable storage medium. The processing resource and the machine-readable storage medium may be example representatives of the processing resource 104 and the machine-readable storage medium 106 of the AP 100 of FIG. 1. As an alternative or in addition to retrieving and executing instructions, the processing resource may include one or more electronic circuits that include electronic components for performing the functionality of one or more instructions, such as an FPGA, ASIC, or other electronic circuits. Further, the flow charts that are shown in FIGS. 2-4 include several steps in a particular order. However, the order of steps shown in the respective flowcharts should not be construed as the only order for the steps. The steps may be performed at any time, in any order. Additionally, the steps may be repeated or omitted as needed.

FIG. 2 depicts a flowchart of an example a method 200 for managing MBSSID groups. The method 200 may be performed by an AP, such as the AP 100 of FIG. 1. As described in conjunction with FIG. 1, a radio of the VAP may be configured with a plurality of VAPs (e.g., the VAPs 110A-11D), and the VAPs are grouped into a plurality of MBSSID groups. Further, the AP maintains a VAP configuration (see Table 1, for example) that includes information about the VAPs (e.g., the VAPs 110A-11D) hosted by the AP for the radio. Further, as previously noted, in each MBSSID group, one of the VAPs may be configured as a transmitted VAP, and the rest of the VAPs of that group are configured as non-transmitted VAPs. The VAP configuration may include details about an MBSSID group, a VAP type (e.g., classification as to a transmitted VAP or a non-transmitted VAP), and an encryption algorithm (e.g., a group management cipher suite) mapped to each of the VAPs for the radio.

At step 202, the AP may receive a configuration of a target VAP. In the context of the method 200, a newly created VAP or an updated VAP with a modified encryption algorithm is referred to as a target VAP. In one example, the AP may fetch a VAP configuration of the target VAP from a VAP configuration data store maintained by the AP. The VAP configuration fetched by the AP may include information about the encryption algorithm assigned to the target VAP. The encryption algorithm assigned to the target VAP is hereinafter referred to as a first encryption algorithm.

Further, at step 204, the AP may perform a check to determine whether the first encryption algorithm matches an encryption algorithm corresponding to one of a plurality of transmitting VAPs of the plurality of MBSSID groups. In particular, at step 204, the AP may compare the first encryption algorithm with the encryption algorithms corresponding to each transmitted VAP for the radio. At step 204, if it is determined that the first encryption algorithm matches the encryption algorithm corresponding to one of the plurality of transmitting VAPs, the AP, at step 206, may assign a given MBSSID group whose transmitting VAP's encryption algorithm matches the first encryption algorithm (see example cases described for the newly created VAP_N2 and updated VAP 110D described in conjunction with FIG. 1). In particular, the target VAP may be configured as a non-transmitting VAP in the given MBSSID group. In some examples, the AP may allocate the given MBSSID group to the target VAP provided the maximum VAP capacity of the given MBSSID group is not exhausted.

However, at step 204, if it is determined that the first encryption algorithm does not match the encryption algorithm corresponding to any of the plurality of transmitting VAPs, the AP, at step 208, creates an additional MBSSID group for the target VAP (see an example case described for the newly created VAP_N1 and updated VAP 110B described in conjunction with FIG. 1). After creating the additional MBSSID group, the AP, at step 210, may configure the target VAP as a transmitting VAP for the additional MBSSID group. Further, at step 212, the AP may transmit a management frame corresponding to the additional MBSSID group. In particular, the management frame may include security information generated via the first encryption algorithm. In particular, to enable the beacon protection per Wi-Fi 7, the AP may create an MBSSID beacon for the additional MBSSID group created at step 208. In this MBSSID beacon, the AP may include security information (e.g., BIGTK and BIPN) generated via the first encryption algorithm of the target VAP. In some examples, to generate the security information for the MBSSID, the AP may execute the respective encryption algorithm.

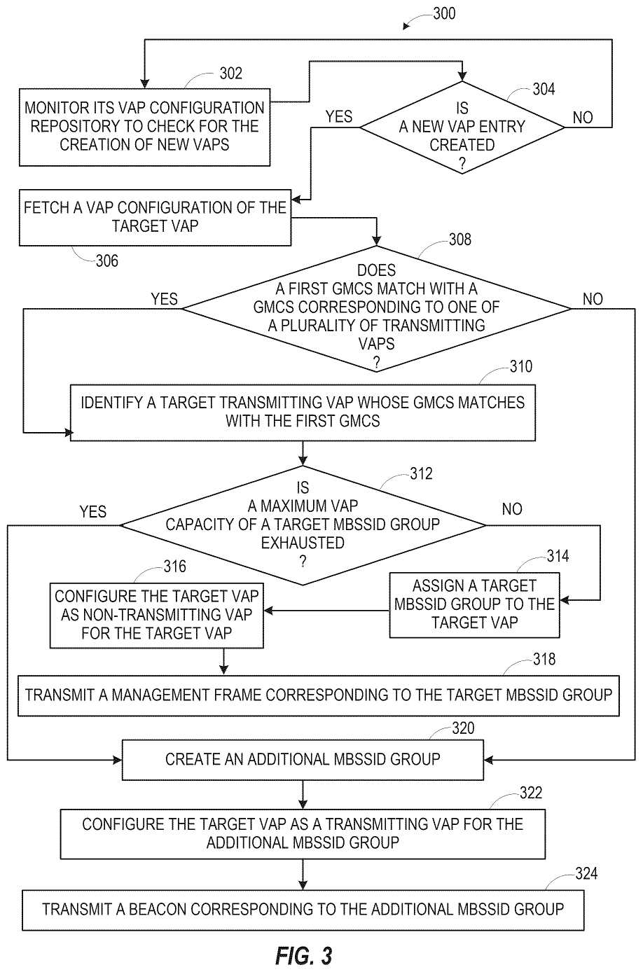

Turning now to FIG. 3, a flowchart of another example method 300 for managing MBSSID groups for a newly created VAP is presented. The method 300 of FIG. 3 includes certain steps that are similar to those described in FIG. 2, certain details of which are not repeated herein for the sake of brevity.

The method 300 may be performed by an AP, such as the AP 100 of FIG. 1. As described in conjunction with FIG. 1, a radio of the VAP may be configured with a plurality of VAPs (e.g., the VAPs 110A-11D), and the VAPs are grouped into a plurality of MBSSID groups. Further, the AP maintains a VAP configuration repository (see Table 1, for example) that includes information about the VAPs (e.g., the VAPs 110A-11D) hosted by the AP for the radio. Further, as previously noted, in each MBSSID group, one of the VAPs may be configured as a transmitted VAP, and the rest of the VAPs of that group are configured as non-transmitted VAPs. The VAP configuration may include details about an MBSSID group, a VAP type (e.g., classification as to a transmitted VAP or a non-transmitted VAP), and an encryption algorithm (e.g., a group management cipher suite) mapped to each of the VAPs for the radio.

In some examples, the AP, at step 302, may monitor its VAP configuration repository to check for the creation of new VAPs. In one example, the VAP configuration repository may be stored locally within the AP or remotely on a storage system accessible to the AP. A user such as an administrator user of the AP may create a VAP by accessing a web console facilitated by the AP or a centralized cloud-based VAP management system. In the context of method 300, a newly created VAP is referred to as a target VAP. The examples of the newly created VAP may be VAP_N1 and VAP_N2 (described in conjunction with FIG. 1). Whenever a VAP is created, a new VAP entry is created in the VAP configuration repository. The VAP entry corresponding to the target VAP may include information such as a VAP type, an MBSSID group, and an encryption algorithm assigned to the target VAP.

At step 304, the AP may perform and check to determine whether a new VAP entry has been created in the VAP configuration repository. Based on the monitoring at step 302, if it is determined that the VAP configuration repository is modified with any new VAP entry, the AP may determine that the new VAP entry has been created. At step 304, if it is determined that no new VAP entry has been created, the AP may continue monitoring the VAP configuration repository at step 302. However, at step 304, if it is determined that the new VAP entry has been created, the AP, at step 306, may fetch a VAP configuration of the target VAP. In particular, the AP may access the VAP configuration specified in the new VAP entry. For example, for VAP_N1 (see Table 2), the AP may determine that VAP_N1 is configured as a non-transmitting VAP for the MBSSID group MG1 configured with the group management cipher suite BIP-CMAC-256. Similarly, upon detecting the creation of VAP_N2, the AP may determine that VAP_N2 is configured as a non-transmitting VAP for the MBSSID group MG1 configured with the group management cipher suite BIP-GMAC-256. The group management cipher suite of the target VAP (e.g., the newly created VAP) is hereinafter referred to as a first group management cipher suite.

Further, at step 308, the AP may perform a check to determine whether the first group management cipher suite (first GMCS) matches a group management cipher suite corresponding to one of a plurality of transmitting VAPs of the plurality of MBSSID groups configured for the same radio of the AP. In particular, at step 308, the AP may compare the first group management cipher suite with the group management cipher suites corresponding to each transmitted VAP for the radio. At step 308, if it is determined that the first group management cipher suite matches the group management cipher suite corresponding to one of the plurality of transmitting VAPs, the AP, at step 310, may identify a target transmitting VAP from the plurality of transmitting VAPs whose group management cipher suite matches with the first group management cipher suite. The MBSSID group of the target transmitting VAP is referred to as a target MBSSID group. In the above example of VAP_N2, the group management cipher suite BIP-GMAC-256 matches the group management cipher suite of VAP 110C which is the transmitted VAP of MG2. Accordingly, for a target VAP such as VAP_N2, the AP may identify VAP 110C as the target transmitting VAP and MG2 as the target MBSSID group.

Furthermore, at step 312, the AP may perform another check to determine whether a VAP capacity of the target MBSSID group has been exhausted. In particular, to perform this task at step 312, the AP may compare a count of VAPs already allocated to the target MBSSID group with the VAP capacity of the target MBSSID group. If the count of VAPs already allocated to the target MBSSID group is lower than the VAP capacity of the target MBSSID group, the AP may determine that the VAP capacity of the target MBSSID group is not yet exhausted and more VAPs may be allocated to the target MBSSID group. However, if the count of VAPs already allocated to the target MBSSID group is equal to the VAP capacity of the target MBSSID group, the AP may determine that the VAP capacity of the target MBSSID group has been exhausted and no more VAPs may be allocated to the target MBSSID group.

Accordingly, at step 312, if it is determined that the VAP capacity of the target MBSSID group is not yet exhausted, the AP, at step 314, may assign the target VAP to the target MBSSID group. For the ongoing example of VAP_N2, responsive to determining that the VAP capacity of MG2 has not been exhausted, the AP, at step 314, may assign VAP_N2 to MG2 (see Table 3). Further, at step 316, the AP may configure the target VAP as a non-transmitting VAP for the target MBSSID group. Furthermore, at step 318, the AP may transmit a management frame corresponding to the target MBSSID group containing information about its original group management cipher suite (e.g., the group management cipher suite of VAP 110C which is BIP-GMAC-256). In particular, the MBSSID beacon for MG2 may include security information (e.g., BIGTK and BIPN) corresponding to BIP-GMAC-256.

Further, referring to steps 312 and 308, if it is determined, at step 308, that the first group management cipher suite does not match the group management cipher suite corresponding to any of the plurality of transmitting VAPs, or if it is determined, at step 312, that the VAP capacity of the target MBSSID group has been exhausted, the AP may execute step 320. In particular, at step 320, the AP may create an additional MBSSID group for the target VAP. For the ongoing example of VAP_N1, responsive to determining that the VAP capacity of MG2 has been exhausted or determining that the group management cipher suite of the VAP_N1 (i.e., BIP-CMAC-256) does not match the group management cipher suite of any of the transmitted VAPs of MG1 and MG2, the AP 100 creates an additional MBSSID group MG3 specifically for VAP_N1.

After creating the additional MBSSID group, the AP, at step 322, may configure the target VAP as a transmitting VAP for the additional MBSSID group. Further, at step 324, the AP may transmit a management frame corresponding to the additional MBSSID group containing information about the first encryption algorithm. In particular, to enable the beacon protection per Wi-Fi 7, the AP may create an MBSSID beacon for the additional MBSSID group created at step 318. In this MBSSID beacon, the AP may include security information (e.g., BIGTK and BIPN) corresponding to the first encryption algorithm of the target VAP.

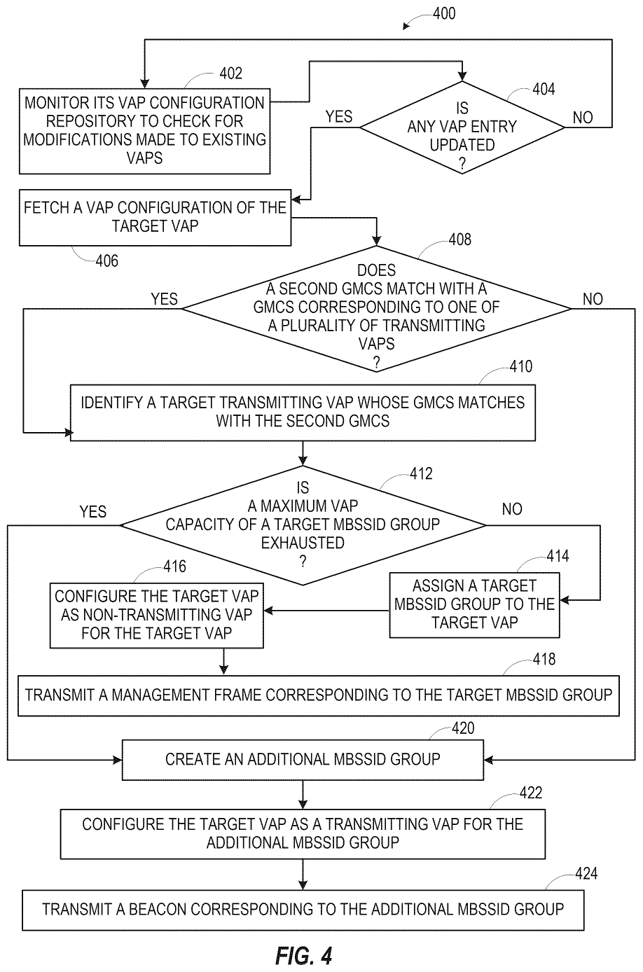

Turning now to FIG. 4, a flowchart of an example method 400 for managing MBSSID groups when an existing VAP is modified is presented. The method 400 of FIG. 4 includes certain steps that are similar to those described in FIG. 2 or 3, certain details of which are not repeated herein for the sake of brevity. The method 400 may be performed by an AP, such as the AP 100 of FIG. 1 configured with a plurality of VAPs (e.g., the VAPs 110A-11D) for a radio. The VAPs are grouped into a plurality of MBSSID groups. Further, the AP maintains a VAP configuration repository (see Table 1, for example) that includes information about the VAPs (e.g., the VAPs 110A-11D) hosted by the AP for the radio.

The AP, at step 402, may monitor its VAP configuration repository to check for the modifications made to the existing VAPs. For example, a user such as an administrator user of the AP may modify an existing VAP by accessing a web console facilitated by the AP or a centralized cloud-based VAP management system. In the context of method 400, an existing VAP that is modified is referred to as a target VAP, and a group management cipher suite assigned to the VAP before the VAP is modified is referred to as a first group management cipher suite. The modifications made to the VAP may include replacing the first group management cipher suite with a different second group management cipher. Examples of the updated VAPs may be VAPs 110B and 110C (see Table 5). Whenever a VAP is updated with a different group management cipher suite, the VAP entry corresponding to the VAP is modified in the VAP configuration repository, particularly specifying the new group management cipher suite. As shown in Table 5, the VAPs 110B and 110D are updated to modify the respective group management cipher suites to BIP-GMAC-128 and BIP-CMAC-256, respectively.

At step 404, the AP may perform and check to determine whether any VAP entry has been updated in the VAP configuration repository. At step 404, if it is determined that no VAP entry has been updated, the AP may continue monitoring the VAP configuration repository at step 402. However, at step 404, if it is determined that a VAP entry has been updated, the AP, at step 406, may fetch a VAP configuration of the target VAP. In particular, the AP may access the VAP configuration specified in the new VAP entry. For example, for VAPs 110B and 110D, the AP may determine that VAPs 110B and 110D are updated to modify the respective group management cipher suites to BIP-GMAC-128 and BIP-CMAC-256, respectively.

Further, at step 408, the AP may perform a check to determine whether the second group management cipher suite (e.g., second GMCS—the modified group management cipher suite) matches a group management cipher suite corresponding to one of a plurality of transmitting VAPs of the plurality of MBSSID groups configured for the same radio of the AP. At step 408, if it is determined that the second group management cipher suite matches the group management cipher suite corresponding to one of the plurality of transmitting VAPs, the AP, at step 410, may identify a target transmitting VAP from the plurality of transmitting VAPs whose group management cipher suite matches with the second group management cipher suite. The MBSSID group of the target transmitting VAP is referred to as a target MBSSID group. In the above example of VAP 110D, the group management cipher suite BIP-CMAC-256 matches the group management cipher suite of VAP_N1 which is the transmitted VAP of MG3. Accordingly, for a target VAP such as VAP 110D, the AP may identify VAP_N1 as the target transmitting VAP and MG3 as the target MBSSID group.

Furthermore, at step 412, the AP may perform another check to determine whether a VAP capacity of the target MBSSID group (e.g., MG3) has been exhausted (similarly as described in conjunction with FIG. 3). At step 412, if it is determined that the VAP capacity of the target MBSSID group is not yet exhausted, the AP, at step 414, may assign the target VAP to the target MBSSID group. For the ongoing example of VAP 110D, responsive to determining that the VAP capacity of MG3 has not been exhausted, the AP may assign VAP 110D to MG3 (see Table 6). Further, at step 416, the AP may configure the target VAP as a non-transmitting VAP for the target MBSSID group. Furthermore, at step 418, the AP may transmit a management frame corresponding to the target MBSSID group containing information about its original group management cipher suite (e.g., the group management cipher suite of VAP_N1 is BIP-CMAC-256). In particular, the MBSSID beacon for MG3 may include security information (e.g., BIGTK and BIPN) corresponding to BIP-CMAC-256.

Further, referring to steps 412 and 408, if it is determined, at step 408, that the second group management cipher suite does not match the group management cipher suite corresponding to any of the plurality of transmitting VAPs, or if it is determined, at step 412, that the VAP capacity of the target MBSSID group has been exhausted, the AP may execute step 420. In particular, at step 420, the AP may create an additional MBSSID group for the target VAP. Responsive to determining that the VAP capacity of MG2 has been exhausted or determining that the group management cipher suite of the target does not match the group management cipher suite of any of the transmitted VAPs, the AP 100 creates an additional MBSSID group, for example, MG4. In the example of the VAP 110B being the target VAP, the AP may determine (at step 412) that the group management cipher suite BIP-GMAC-128 does not match with any of the transmitting VAPs at the time the VAP 110B was created, accordingly, the AP 100 creates the additional MBSSID group-MG4.

After creating the additional MBSSID group, the AP, at step 422, may configure the target VAP as a transmitting VAP for the additional MBSSID group. Further, at step 424, the AP may transmit a management frame corresponding to the additional MBSSID group containing information about the first encryption algorithm. In particular, to enable the beacon protection per Wi-Fi 7, the AP may create an MBSSID beacon for the additional MBSSID group created at step 418. In this MBSSID beacon, the AP may include security information (e.g., BIGTK and BIPN) corresponding to the first encryption algorithm of the target VAP.

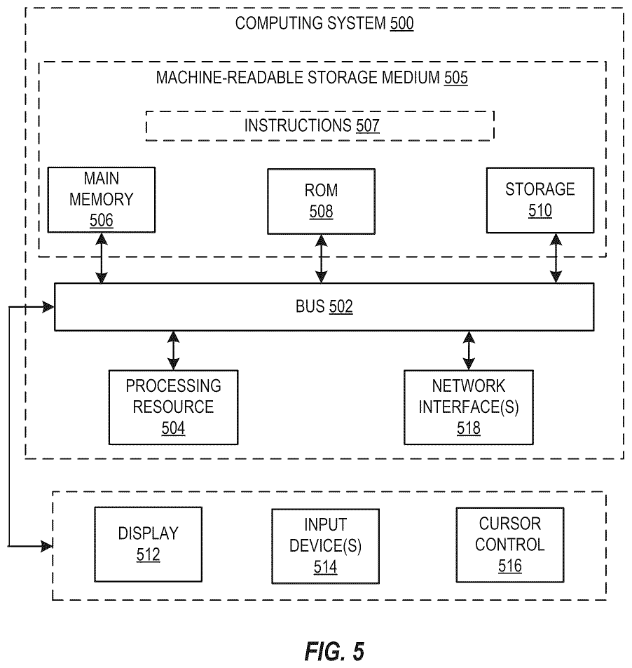

FIG. 5 depicts a block diagram of an example computing system 500 in which various of the examples described herein may be implemented. In some examples, the computing system 500 may be configured to operate as a wireless networking device, for example, an AP can perform various operations described in one or more of the earlier drawings. For instance, the computing system 500 may be an example representative of the AP 100 of FIG. 1.

The computing system 500 may include a bus 502 or other communication mechanisms for communicating information, a hardware processor, also referred to as processing resource 504, and a machine-readable storage medium 505 coupled to the bus 502 for processing information. In some examples, the processing resource 504 may include one or more CPUs, semiconductor-based microprocessors, and/or other hardware devices suitable for retrieval and execution of instructions stored in a machine-readable storage medium 505. The processing resource 504 may fetch, decode, and execute instructions, to configure a plurality of MBSSID groups, in accordance with examples presented herein. As an alternative or in addition to retrieving and executing instructions, the processing resource 504 may include one or more electronic circuits that include electronic components for performing the functionality of one or more instructions, such as an FPGA, an ASIC, or other electronic circuits.

In some examples, the machine-readable storage medium 505 may include a main memory 506, such as a RAM, cache, and/or other dynamic storage devices, coupled to the bus 502 for storing information and instructions to be executed by the processing resource 504. The main memory 506 may also be used for storing temporary variables or other intermediate information during the execution of instructions to be executed by the processing resource 504. Such instructions, when stored in storage media accessible to the processing resource 504, render the computing system 500 into a special-purpose machine that is customized to perform the operations specified in the instructions. The machine-readable storage medium 505 may further include a read-only memory (ROM) 508 or other static storage device coupled to the bus 502 for storing static information and instructions for the processing resource 504. Further, in the machine-readable storage medium 505, a storage device 510, such as a magnetic disk, optical disk, or USB thumb drive (Flash drive), etc., may be provided and coupled to the bus 502 for storing information and instructions.

Further, in some implementations, the computing system 500 may be coupled, via the bus 502, to a display 512, such as a liquid crystal display (LCD) (or touch-sensitive screen), for displaying information to a computer user. In some examples, an input device 514, including alphanumeric and other keys (physical or software generated and displayed on a touch-sensitive screen), may be coupled to the bus 502 for communicating information and command selections to the processing resource 504. Also, in some examples, another type of user input device may be a cursor control 516, such as a mouse, a trackball, or cursor direction keys that may be connected to the bus 502. The cursor control 516 may communicate direction information and command selections to the processing resource 504 for controlling cursor movement on the display 512. In some other examples, the same direction information and command selections as cursor control may be implemented via receiving touches on a touch screen without a cursor.

In some examples, the computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 500 also includes a network interface 518 coupled to bus 502. The network interface 518 provides a two-way data communication coupling to one or more network links that are connected to one or more local networks. For example, the network interface 518 may be an integrated services digital network (ISDN) card, cable modem, satellite modem, or a modem to provide a data communication connection to a corresponding type of telephone line. As another example, the network interface 518 may be a local area network (LAN) card or a wireless communication unit (e.g., Wi-Fi chip/module).

In some examples, the machine-readable storage medium 505 (e.g., one or more of the main memory 506, the ROM 508, or the storage device 510) stores instructions 507 which when executed by the processing resource 504 may cause the processing resource 504 to execute one or more of the methods/operations described hereinabove. The instructions 507 may be stored on any of the main memory 506, the ROM 508, or the storage device 510. In some examples, the instructions 507 may be distributed across one or more of the main memory 506, the ROM 508, or the storage device 510. In some examples, when the computing system 500 is configured to operate as an AP, the instructions 507 may include instructions which when executed by the processing resource 504 may cause the processing resource 504 to perform one or more of the methods described in FIGS. 2-4.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, etc., may be used herein to describe various elements, these elements should not be limited by these terms, as these terms are only used to distinguish one element from another unless stated otherwise or the context indicates otherwise.

What is claimed is:

1. A method comprising:
receiving, by an Access Point (AP), a configuration of a target Virtual Access Point (VAP), wherein the configuration comprises information about a first encryption algorithm corresponding to the target VAP configured for a radio, and wherein the radio is configured with a plurality of Multiple Basic Service Set Identifier (MBSSID) groups;
determining, by the Access Point (AP), whether the first encryption algorithm matches with an encryption algorithm corresponding to one of a plurality of transmitting VAPs of the plurality of MBSSID groups;
creating, by the AP, an additional MBSSID group for the target VAP in response to determining that the first encryption algorithm does not match the encryption algorithm corresponding to any of the plurality of transmitting VAPs of the radio;
configuring, by the AP, the target VAP as a transmitting VAP for the additional MBSSID group; and
transmitting, by the AP, a management frame comprising security information corresponding to the first encryption algorithm.

2. The method of claim 1, further comprising:
identifying, by the AP, a target transmitting VAP of the plurality of transmitting VAPs whose encryption algorithm matches with the first encryption algorithm, wherein the target transmitting VAP corresponds to a target MBSSID group of a plurality of MBSSID groups configured for the radio;
determining, by the AP, whether a maximum VAP capacity of the target MBSSID group is exhausted; and
creating, by the AP, the additional MBSSID group for the target VAP in response to determining that the maximum VAP capacity of the target MBSSID group has been exhausted.

3. The method of claim 2, further comprising assigning the target VAP to the target MBSSID group in response to determining that the maximum VAP capacity of the target MBSSID group is not yet exhausted.

4. The method of claim 1, further comprising creating the target VAP with the first encryption algorithm.

5. The method of claim 1, further comprising selecting the first encryption algorithm from Broadcast/Multicast Integrity Protocol (BIP)-Cipher-based Message Authentication Code (CMAC)-128, BIP-Galois Message Authentication Code (GMAC)-128, BIP-GMAC-256, or BIP-CMAC-256.

6. The method of claim 5, wherein the security information comprises one or both of a Beacon Integrity Group Temporal Key (BIGTK) or a BIGTK packet number (BIPN) generated via the first encryption algorithm.

7. The method of claim 1, wherein the radio is configured to transmit radio signals over the 6 Gigahertz (GHz) Wireless-Fidelity (Wi-Fi) band specified in the Institute of Electrical and Electronics Engineers (IEEE) 802.11 Standard Specifications.

8. The method of claim 1, wherein receiving the configuration further comprises:
detecting, by the AP, a new Virtual Access Point (VAP) entry comprising the configuration corresponding to the target VAP in a VAP configuration repository indicating creation of the target VAP for the radio; and
fetching the configuration from the VAP configuration repository responsive to detecting the new VAP entry in the VAP configuration repository.

9. The method of claim 1, further comprising updating an encryption algorithm of the target VAP to the first encryption algorithm, wherein the AP receives the configuration responsive to updating the encryption algorithm of the target VAP.

10. An Access Point (AP) comprising:
a non-transitory machine-readable storage medium storing executable instructions; and
a processing resource coupled to the non-transitory machine-readable storage medium and configured to execute one or more of the instructions to:
detecting a new Virtual Access Point (VAP) entry comprising a configuration corresponding to a target VAP indicating creation of the target VAP for a radio, wherein the configuration comprises information about a first group management cipher suite corresponding to the target VAP, and wherein the radio is configured with a plurality of Multiple Basic Service Set Identifier (MBSSID) groups;
fetching the configuration responsive to detecting the new VAP entry;
determine whether the first group management cipher suite matches with a group management cipher suite corresponding to one of a plurality of transmitting VAPs of the plurality of MBSSID groups;
create an additional MBSSID group for the target VAP in response to determining that the first group management cipher suite does not match the group management cipher suite corresponding to any of the plurality of transmitting VAPs;
configure the target VAP as a transmitting VAP for the additional MBSSID group; and
transmit a beacon comprising security information corresponding to the first group management cipher suite.

11. The AP of claim 10, wherein the processing resource is configured to execute one or more of the instructions to:
identify a target transmitting VAP of the plurality of transmitting VAPs whose group management cipher suite matches with the first group management cipher suite, wherein the target transmitting VAP corresponds to a target MBSSID group of the plurality of MBSSID groups for the radio; and
create the additional MBSSID group for the target VAP in response to determining that the maximum VAP capacity of the target MBSSID group has been exhausted.

12. The AP of claim 11, wherein the processing resource is configured to execute one or more of the instructions to assign the target VAP to the target MBSSID group in response to determining that the maximum VAP capacity of the target MBSSID group is not yet exhausted.

13. The AP of claim 10, wherein the processing resource is configured to execute one or more of the instructions to select the first group management cipher suite from Broadcast/Multicast Integrity Protocol (BIP)-Cipher-based Message Authentication Code (CMAC)-128, BIP-Galois Message Authentication Code (GMAC)-128, BIP-GMAC-256, or BIP-CMAC-256.

14. The AP of claim 13, wherein the security information comprises one or both of a Beacon Integrity Group Temporal Key (BIGTK) or a BIGTK packet number (BIPN) generated via the first group management cipher suite.

15. The AP of claim 10, wherein the radio is configured to transmit radio signals over the 6 Gigahertz (GHz) Wireless-Fidelity (Wi-Fi) band specified in the Institute of Electrical and Electronics Engineers (IEEE) 802.11 Standard Specifications.

16. An Access Point (AP) comprising:
a non-transitory machine-readable storage medium storing executable instructions; and
a processing resource coupled to the non-transitory machine-readable storage medium and configured to execute one or more of the instructions to:
determine that a configuration of a target Virtual Access Point (VAP) corresponding to a radio is updated to replace a first group management cipher suite previously assigned to the target VAP with a second group management cipher suite different from the first group management cipher suite, wherein the radio is configured with a plurality of Multiple Basic Service Set Identifier (MBSSID) groups;
responsive to determining that the configuration of the target VAP has been updated, determine whether the second group management cipher suite matches with a group management cipher suite corresponding to one of a plurality of transmitting VAPs of the plurality of MBSSID groups in response to determining that the configuration of the target VAP has been updated;
create an additional MBSSID group for the target VAP in response to determining that the second group management cipher suite does not match the group management cipher suite corresponding to any of the plurality of transmitting VAPs; and
configure the target VAP as a transmitting VAP for the additional MBSSID group.

17. The AP of claim 16, wherein the processing resource is configured to execute one or more of the instructions to:
identify a target transmitting VAP of the plurality of transmitting VAPs whose group management cipher suite matches with the second group management cipher suite, wherein the target transmitting VAP corresponds to a target MBSSID group of the plurality of MBSSID groups for the radio; and
create the additional MBSSID group for the target VAP in response to determining that the maximum VAP capacity of the target MBSSID group has been exhausted.

18. The AP of claim 17, wherein the processing resource is configured to execute one or more of the instructions to assign the target VAP to the target MBSSID group in response to determining that the maximum VAP capacity of the target MBSSID group is not yet exhausted.

19. The AP of claim 18, wherein the processing resource is configured to execute one or more of the instructions to select the second group management cipher suite from Broadcast/Multicast Integrity Protocol (BIP)-Cipher-based Message Authentication Code (CMAC)-128, BIP-Galois Message Authentication Code (GMAC)-128, BIP-GMAC-256, or BIP-CMAC-256.

20. The AP of claim 16, wherein the radio is configured to transmit radio signals over the 6 Gigahertz (GHz) Wireless-Fidelity (Wi-Fi) band specified in the Institute of Electrical and Electronics Engineers (IEEE) 802.11 Standard Specifications.
